(19) United States
(12) Patent Application Publication
(10) Pub. No.: US 2023/0010927 A1
(43) Pub. Date: Jan. 12, 2023

(54) Quick Fix Yum Yum Mix

(71) Applicant: Cheryl Shelton Iaquinta, Cadiz, KY (US)

(72) Inventor: Cheryl Shelton Iaquinta, Cadiz, KY (US)

(21) Appl. No.: 17/371,792

(22) Filed: Jul. 9, 2021

(51) Int. Cl. A23L 27/14; A23L 29/30

(52) U.S. Cl. CPC A23L 27/14; A23L 29/30

(57) ABSTRACT

A new and novel composition of matter using dry, dehydrated spices and sweetener to formulate a dry spice mixture called Quick Fix Yum Yum Mix. Quick Fix Yum Yum Mix produces a sauce, commonly known as Yum Yum sauce when mayonnaise and water are added. The dry spice mix is comprised of spray dried butter powder derived from pasteurized cream & nonfat dry milk and mixed with powdered garlic, powdered paprika, granulated sugar, and powdered tomato. These spices and sweetener are thoroughly mixed together and the mixture is then ready for use and placed in light weight, shelf stable packaging. This provides a new method of producing Yum Yum sauce at need. When mayonnaise and water are added to the dry spice mix it produces Yum Yum sauce for dipping and salad dressing. This product is sensorily highly acceptable and is microbiologically safe.

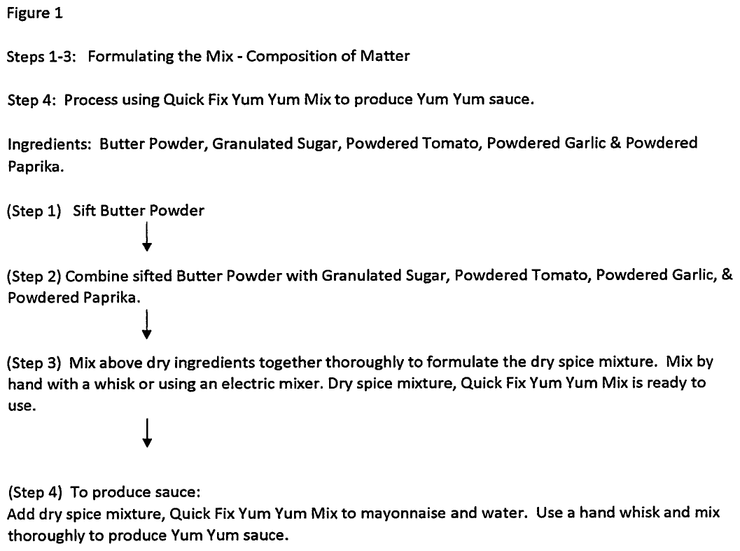

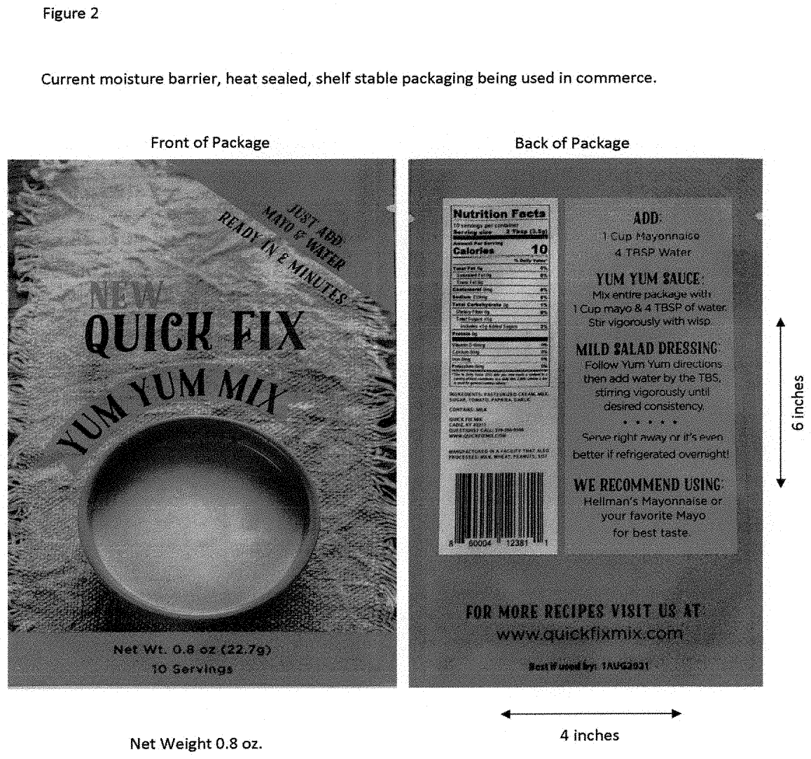

### FIELD OF INVENTION

The present invention relates to a new, novel composition of dry (dehydrated) spices that when added to mayonnaise and water produces what is commonly known as Yum Yum sauce and a process for preparing the same.

### BACKGROUND OF INVENTION

Yum Yum Sauce is traditionally served in Hibachi style restaurants and has only been available in liquid form in grocery or restaurant settings in recent years. As related in a 2019 NPR article, Food For Thought; Yum Yum Sauce: The Making Of An American Condiment, written Jul. 29, 2019 by Oliver Whang, he noted: “One of the more subtle curiosities of teppanyaki restaurants—beyond the stacked onion rings of fire and behind-the-back toss of metal utensils—is a creamy orange-pink sauce placed beside your steaming meal. Almost every teppanyaki restaurant will serve it, though its name differs depending on whom you talk to. White sauce (a deceptive moniker), shrimp sauce, yummy sauce, yum yum sauce—are all used interchangeably.”

“The recipe for the sauce is equally difficult to come by. I reached out to 15 different restaurants around the U.S.—large chains and independently run joints—but each turned down my request. “We cannot divulge that information,” a Benihana manager in Maryland told me. I received similar answers from a Sakura in New Jersey, an Edohana in Texas and a Flame in New York.

Chuck Cutler ran into a very similar problem 25 years ago, when he first tasted what he calls white sauce in a teppanyaki restaurant. “I noticed that all the other people at the table were asking for two bowls of white sauce . . . so I tried it. I was instantly hooked.”

Cutler spent a decade asking different restaurants for the recipe, to no avail. “It's a Japanese secret,” chefs would tell him. One day, though, in a Florida grocery store, he stumbled across a sauce produced by a teppanyaki restaurant. He remembers it being called vegetable sauce. So, he bought a bottle “and darned if it didn't taste exactly like what I had been looking for.”

“The popularity and intrigue around the sauce led one teppanyaki restaurant owner, Terry Ho, to start bottling it in bulk. “Ho's sauce is called Terry Ho's Yum Yum Sauce.” This sauce in liquid form is sold in over 30,000 grocery stores and in most military commissaries state side and overseas. There are many other liquid sauces, but Terry Ho's is the most common.

Yum Yum sauces available for purchase from a grocer or restaurant are liquid products made from liquid ingredients. Recipes available to the public, also require liquid ingredients. Liquid products are bulky in storage and heavy in shipping, must be refrigerated after opening, leading to expiration and waste.

It is for these reasons Quick Fix Yum Yum Mix was created, not to mention taste. It's the first dry spice mix, that produces Yum Yum sauce. It's compact, shelf stable, and a quick and easy way to produce Yum Yum sauce at home or in a commercial setting.

### SUMMARY OF THE INVENTION

Accordingly, the present invention relates to a composition of dry spices and sweetener, comprised of Spray Dry Butter Powder derived from Butter (Pasteurized Cream), Nonfat Dry Milk in the amount of 13.3 g, sifted and then combined with Granulated Sugar 9.37 g, Powdered Tomato 0.9 g, Powdered Garlic 0.19 g, Powdered paprika 0.29 g and mixed together to formulate a dry spice mixture named, Quick Fix Yum Yum Mix.

The novelty of the present invention is the mixing of dry spices and sweetener to formulate a dry mix, packaged for home or commercial use, that when combined with mayonnaise and water, produces a sauce, commonly called Yum Yum sauce. This new and novel formula of dry spice mix, (Quick Fix Yum Yum Mix) produces a shelf stable dry spice mix that is light weight, and compact in size for efficient and cost-effective shipping and storage. This product is sensorily highly acceptable, and is microbiologically safe.

### OBJECTIVE OF THE INVENTION

The main objective of the present invention is to provide a new, novel process for making a commonly known sauce called Yum Yum Sauce by using dry (dehydrated) spices and sweetener in a easy to use spice packet.

Yet another objective is to develop a shelf stable, dry spice mix that produces Yum Yum sauce at need and reduces waste of liquid product that requires refrigeration after opening.

Yet another objective is to develop a dry spice mixture that produces Yum Yum sauce that is light in weight and compact in size for efficient and cost-effective shipping and storage.

### BRIEF DESCRIPTION OF DRAWING 1

The FIGURE broadly illustrates a flow diagram of formulating Quick Fix Yum Yum Mix. It also illustrates the use of the mix to produce Yum Yum Sauce.

### Brief Description of Drawing 2

The FIGURE broadly illustrates the packaging currently being used in commerce.

### DETAILED DESCRIPTION

A new and novel composition of matter consisting of specific dehydrated dry spices and sweetener, formulated into a dry spice mixture called Quick Fix Yum Yum Mix. The mixture is then used in a process for the preparation of a sauce, commonly known as Yum Yum sauce. The first ingredient being Spray Dry Butter Powder derived from Butter (Pasteurized Cream) and Nonfat Dry Milk in the amount of 13.3 g is sifted, then combined with Granulated Sugar 9.37 g, Powdered Tomato 0.9 g, Powdered Garlic 0.19 g, Powdered Paprika 0.29 g. These ingredients arm mixed together thoroughly by a hand whisk or electric mixer to produce a dry spice mixture called Quick Fix Yum Yum Mix. Quick Fix Yum Yum Mix is then ready for use in the process of making a sauce, commonly known as Yum Yum sauce. This new and novel dry spice mixture is shelf stable, compact and light-weight (24.05 g or 0.8 oz). The current packaging is a small 4×8 moisture barrier packet. It is an improvement to bottles of liquid sauce currently available, which are bulky in size and weight, heavy in shipping and not shelf stable after opening. This dry spice mixture, Quick Fix Yum Yum Mix is a new a novel composition of dry spices and sweetener formulated and packaged, providing a new and novel process to produce Yum Yum sauce at home or in a commercial setting in short order, at need. The dry spice mixture, Quick Fix Yum Yum Mix is added to 1 cup of mayonnaise and 4 tablespoons of water which produces 10 servings of Yum Yum sauce, each serving being 2 tablespoons.

We claim:

1. A new and novel composition of matter consisting of specific dehydrated dry spices and sweetener, formulated into a dry spice mixture (Quick Fix Yum Yum Mix) and used in a process for the preparation of a sauce, commonly known as Yum Yum sauce, said process comprising the steps of: (i) Using dry spices, the first being Spray Dry Butter Powder derived from Butter (Pasteurized Cream) and Nonfat Dry Milk in the amount of 13.3 g, and sifted (ii) then combined with Granulated Sugar 9.37 g, Powdered Tomato 0.9 g, Powdered Garlic 0.19 g, Powdered Paprika 0.29 g and (iii) mixed together to produce a dry spice mixture (Quick Fix Yum Yum Mix), ready for use in the process of making a sauce, commonly known as Yum Yum sauce. (iv) The dry spice mixture is placed in moisture barrier, heat sealed packaging that is compact and light weight. (v) This dry spice mixture is added to 1 cup of mayonnaise and 4 tablespoons of water which produces 10 servings of Yum Yum sauce, each serving being 2 tablespoons. (vi) This new and novel dry spice mixture is shelf stable, compact and light-weight (24.05 g or 0.8 oz). It is an improvement to bottles of liquid sauce currently available, which are bulky in size and weight, heavy in shipping and not shelf stable after opening. (vii) This dry spice mixture, Quick Fix Yum Yum Mix is a new a novel composition of dry spices and sweetener formulated and packaged together providing a new and novel process to produce Yum Yum sauce in short order, at need which can prevent waste due to the expiration of an opened bottle.

2. A composition of matter as claimed in claim 1 wherein in step (i), the composition of spices and sweetener used are dry (dehydrated, without liquid).

3. A process as claimed in claim 1 wherein in step (i), the Butter product, Spray Dried Butter derived from Butter (Pasteurized Cream) and Nonfat Dry Milk is sifted to a fine powder using a manual or electric sifter.

4. A process as claimed in claim 1 wherein in step (ii), the sifted Butter is combined with Granulated Sugar, Powdered Tomato, Powdered Garlic, and Powdered Paprika.

5. A process as claimed in claim 1 (iii), the combined spices and sweetener are then mixed together thoroughly, mixing is done manually or using an electric mixer, formulating a dry spies mixture (Quick Fix Yum Yum Mix) ready for use in the process of making a sauce, commonly known as Yum Yum Sauce.

6. A process as claimed in claim 1 (iv), the spice mixture (Quick Fix Yum Yum Mix) is placed in moisture barrier, heat sealed packaging that is compact and light weight.

7. A process as claimed in claim 1 (v), the dry spice mixture is added to mayonnaise and water to produce Yum Yum sauce.

8. A process as claimed in claim 1 (vi), the new and novel dry spice mixture allows for Yum Yum sauce production from a shelf stable, compact, light-weight mix packet that is an improvement over bottles of liquid sauce currently available, which are bulky in size and weight, heavy in shipping and not shelf stable after opening.

9. A process as claimed in claim 1 (vii), Quick Fix Yum Yum Mix is a new and novel composition of dry spices and sweetener formulated and packaged together providing a new and novel process to produce Yum Yum sauce in short order, at need which can prevent waste due to the expiration of an opened bottle.
